(19) United States
(12) Patent Application Publication
(10) Pub. No.: US 2004/0247989 A1
(43) Pub. Date: Dec. 9, 2004

(54) Method for making an electrode by depositing nano-particles

(76) Inventors: Colleen Legzdins, (US); Marek Pawlik, Vancouver (CA)

Correspondence Address: BUSKOP LAW GROUP, P.C., 1717 ST. JAMES PLACE, SUITE 500, HOUSTON, TX, 77056, US

(21) Appl. No.: 10/781,421

(22) Filed: Feb. 18, 2004

Related U.S. Application Data
(60) Provisional application No. 60/476,721, filed on Jun. 6, 2003.

(51) Int. Cl. H01M 4/86; B05D 5/12; H01M 4/88

(52) U.S. Cl. 429/44; 502/101; 427/115

(57) ABSTRACT

The invention is a method for making an electrode by depositing nano-particles on an object by forming a nano-particle dispersion, coating an object with the nano-particle dispersion thereby disposing nano-particles from the nano-particle dispersion on the object forming an electric conductor, removing at least a portion of the carrier, forming an electrical circuit using the electric conductor such that electric current flows in at least a portion of a medium using the electric conductor, and connecting the electrical circuit to a load, wherein the nano-particle dispersion has between 0.05 wt % and 10 wt % of a charged soluble polymer having a molecular weight of less than 25,000 amu, between 0.5 wt % and 10 wt % of a metal component, and balance of a carrier.

The present application claims priority to co-pending U.S. Provisional Patent Application Ser. No. 60/476,721 filed on Jun. 6, 2003.

### FIELD OF THE INVENTION

The present invention relates to a method for making an electrode by depositing nano-particles on a micro-structured conductive object with pores or features that are measured in microns or smaller.

### BACKGROUND OF THE INVENTION

Many different types of applications of materials require the use of very fine particles to achieve some objective. In catalytic reactions, not only the catalyst material, but also the morphology of the catalyst and its physical relationship to other components of a reactor are important. A need, therefore, exists to develop methods of creating catalyst particles of a defined and controlled shape and of depositing these particles onto reactor elements.

In non-catalytic applications, the ability to create controlled size distribution of small particles is important. For example, microstructures need to be plated in order to render them electrically conductive. Controlled size distribution of small particles is also important in forming nano-layers on a substrate and in creating alloys by multiple applications of different materials.

Production and deposition of nano-particles is a difficult process. Various methods exist for using nano-particle precursors with a material to reduce the precursor to a nano-particle on the surface of the bulk material. The size distribution of the resulting nano-particles is wide and only limited control is available. Upon heating, sintering occurs and small particles are lost.

Deposition methods, including physical, vapor, and chemical deposition, can coat a thin film of material onto a structure. Deposition yields a smooth surface of uniform thickness on the structure, which is often not desirable. Also, in high aspect ratio microstructures, the vapor material is unable to penetrate to the extreme ends of the structures features.

Slurry casting can be used to deposit materials, but the particle size tends to be large (>1 um).

In general, depositing nano-particles onto a structure, particularly a micro-structure presents difficulties in materials handling, difficulty in controlling the particle size and maintaining the particle size through the deposition process, difficulty in achieving uniform deposition over an entire structure and difficulty achieving optimum particle size upon completion of the deposition process. A need exists for a method of depositing nano-particles onto complex structured substrates that is low cost, that maintains control over particle morphology and that does not involve the use of expensive high energy processes or complex environmental control.

Production of the nano-particles themselves also presents a difficulty. Many nano-particles are made in a dry form by mechanically milling precursor materials to produce nano-powders. Controlling the dispersion of these nano-powders to avoid health risks is both difficult and expensive. Furthermore, converting such nano-powders into a form suitable for deposition requires further processing introducing unnecessary costs in production. Furthermore, the use of mechanical milling to produce nano-powders creates challenges in forming the required control of both particle size and particle morphology.

A need exists to create nano-particles in a form compatible with a deposition method that both provides the ability to control the distribution of the particle size and produces particles with desirable morphology and that does not impose health risks.

Colloidal dispersions have been proposed as a method of handling nano-particles in a safe way with a corresponding path to convenient methods of deposition. These dispersions, though, become thermodynamically unstable when the concentration of the nano-particles becomes high enough to facilitate reasonable deposition rates.

The term “nano-structured materials” generally refers to the formation of porous materials with features sizes measured on the order of nano-meters or Angstrom's. Apart from this, the nano-structured materials are formed in a similar manner to the micro-structured materials.

Creation of complex micro-structures using micro-structured materials presents challenges for the creation of composite structures. Examples of composite structures include the deposition of one or more metals onto or into a microstructure to render the surfaces of the microstructure catalytically active, the deposition of conductive materials onto a microstructure to render the structure conductive, the creation of graded porosity by selectively filling micro-pores with a barrier material or the deposition of micro-particles of micro-porous materials onto some macro-porous carrier.

In all these applications, the deposition of nano-particles and nano-crystals onto a microstructure is difficult using conventional particle deposition techniques. Electrophoretic deposition and electroplating cannot work with nano-sized particles; physical vapor deposition techniques coat the visible surfaces only, with a uniform film and do not provide the opportunity for mixing multiple materials on the micro-structured surface. Furthermore, vapor deposition methods cannot penetrate deeply into a structures micro-features, whether they are pores or formed structures.

The very small feature sizes of the micro-structured material, whether they are porous or non-porous, makes them behave like capillaries. The spontaneous flow of a liquid through a capillary is normally described in terms of the Washburn equation:

$$\frac{{h}^{2}}{t} = \frac{r {γ}_{LV} cos Θ}{2 η}$$

where t is the time needed for a liquid to reach the penetration height/depth of h, r is the capillary radius, γ_{LV} is the liquid surface tension, η is the liquid viscosity, and Θ is the three-phase contact angle between the liquid, its saturated vapor and capillary wall.

All porous materials are conveniently treated as consisting of bundles of capillaries that can be characterized by some effective radius r_{eff} given by the following equation:

$${r}_{eff} = \frac{2 ( 1 - φ )}{φ {ρ}_{s} A}$$

where φ is the volume fraction of solid in the porous material, ρₛ, is the density of solid, and A is the specific surface area per gram of solid.

As the Washburn equation indicates, the penetration rate reaches a maximum value when the liquid completely wets the capillary walls (Θ=0). In the case of hydrophobic solids, such as porous carbons, characterized by large water contact angles (Θ≈90 deg), penetration rates are extremely low but this effect can partly be compensated by using a material with a higher value of r_{eff}, i.e. a material with a small internal specific surface area A. Such capillary size effects were clearly observed in our studies with the use of materials with varying porosity. While the deposition of Pt nano-particles from aqueous dispersions is almost impossible in highly porous and hydrophobic substrates, the same type of substrate with a lower porosity could easily be saturated with aqueous Pt nano-dispersions.

It should also be pointed out that highly hydrophobic solids are easily wetted (Θ=0) by organic solvents with low surface tensions γ_{LV}, e.g. methanol. Therefore, the penetration rates of highly porous and strongly hydrophobic substrates can significantly be increased using water/methanol mixtures. In addition, in our deposition technique the Pt catalyst particles are dispersed in a polymer solution. The adsorption of this polymer onto the internal surfaces of the hydrophobic substrate during deposition renders these surfaces strongly hydrophilic (Θ=0), thus dramatically increasing the penetration rates. The catalyst can, therefore, be deposited uniformly within a certain volume of the substrate.

Fuel cell reactions support the use of micro-structured gas diffusion media directly, but the use of the supported catalyst is problematic in such cases as the size of the supported catalyst particles is too large compared to the feature size of the microstructure.

### SUMMARY OF THE INVENTION

The current invention is a method for making an electrode by depositing nano-particles on an object. The method begins by forming a nano-particle dispersion and coating an object with the nano-particle dispersion thereby disposing nano-particles from the nano-particle dispersion on the object forming an electric conductor. The method continues by removing at least a portion of the carrier and forming an electrical circuit using the electric conductor such that electric current flows in at least a portion of a medium using the electric conductor. The method ends by connecting the electrical circuit to a load.

The nano-particles deposited in the method to make the electrode has between 0.05 wt % and 10 wt % of a charged soluble polymer having a molecular weight of less than 25,000 amu, between 0.5 wt % and 10 wt % of a metal component, and balance of a carrier.

### BRIEF DESCRIPTION OF THE DRAWINGS

The present invention will be explained in greater detail with reference to the appended figures, in which:

FIG. 1 is a schematic of the method.

FIG. 2 shows a conventional fuel cell electrode formed from a micro-porous monolith onto which a catalyst layer has been formed using the present invention.

FIG. 3 shows a cross-section of novel micro-structured fuel cell geometry formed by micromachining a micro-structured monolith onto which a catalyst layer has been deposited using the present invention.

The present invention is detailed below with reference to the listed Figures.

### DETAILED DESCRIPTION OF THE PREFERRED EMBODIMENTS

Before explaining the present invention in detail, it is to be understood that the invention is not limited to the particular embodiments and that it can be practiced or carried out in various ways.

The invention is a method for making an electrode by depositing nano-particles on a micro-structured conductive object. The micro-structured conductive object has pores or features that are measured in microns or smaller. The electrode can be further utilized in a fuel cell.

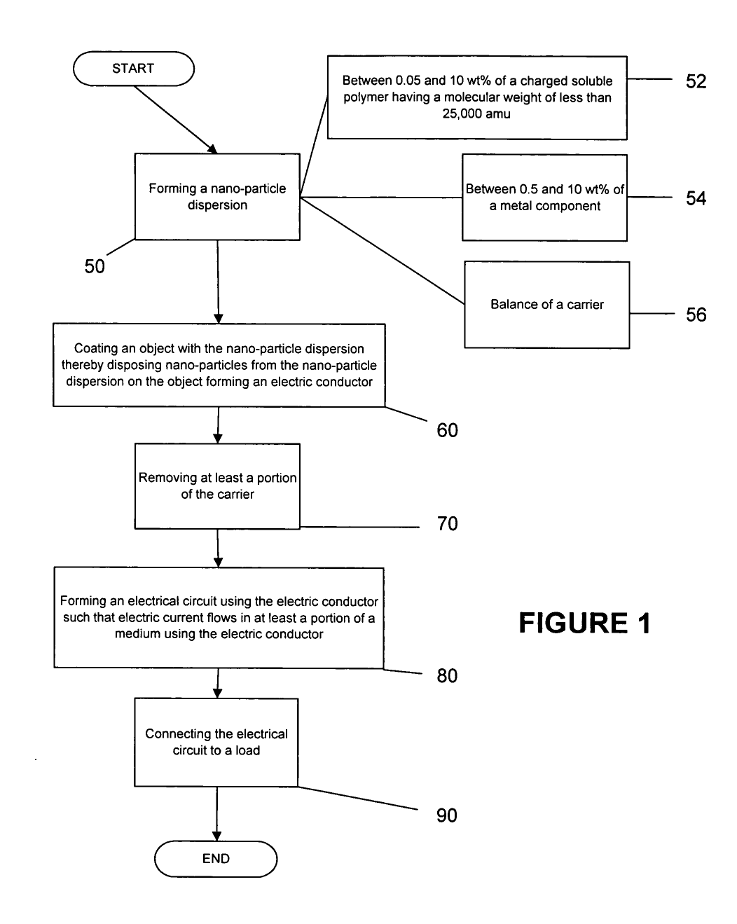

FIG. 1 depicts the method of the invention as a schematic.

The method begins by forming a nano-particle dispersion (50). The nano-particle dispersion is made of a polyacrylate, a noble metal component, and a carrier. The dispersion has nano-particles with a mean average diameter of less than about 10 nm. The nano-particles can be crystals. In the preferred embodiment, the nano-particle dispersion is between 0.05 wt % and 10 wt % of a charged soluble polymer having a molecular weight of less than 25,000 amu (52), between 0.5 wt % and 10 wt % of a metal component (54), and balance of a carrier (56).

The polyacrylate found in the nano-particle dispersion can be sodium acrylate, potassium acrylate, calcium acrylate, or combinations thereof. The noble metal is platinum, ruthenium, palladium, gold, or combinations thereof. In the preferred embodiment, the metal component of the nano-particle dispersion is 30%.

The carrier is water or an alcohol with a lower surface tension than water. The alcohol can be methanol, ethanol, propanol, or combinations thereof. The water can be deionized water or distilled water.

The second step of the method, as seen in FIG. 1, is coating a micro-structured conductive object with the nano-particle dispersion (60). The micro-structured conductive object has features with dimensions of between 50 nanometers and 200 microns.

Examples of micro-structured conductive objects are materials containing a micro-structure, porous materials with micro pores, materials into which a microstructure pattern has been formed, and combinations thereof. The features on micro-structured conductive object have an average width ranging between 50 nanometers and 100 microns.

Other possible features comprise pores, capillaries, channels, voids, ridges, fins, embossments, and combinations thereof. If the features on micro-structured conductive object are pores, capillaries, or voids, the diameter of the features is between 25 nanometers and 10 microns. More possible features are channels, ridges, fins, and embossments with a width and depth that comprises an aspect ratio greater than 2 and an overall width between 100 nanometers and 200 microns.

The coating in the method can be performed by spraying the dispersion on the micro-structured conductive object. In the alternative, the coating can be performed by soaking the micro-structured conductive object in a dispersion. Other methods for the coating of the dispersion on the micro-structured object can include painting, printing, dipping, dripping and combinations thereof. The dripping method is performed by using a computed volume of dispersion to coat a known mass of nano-particles on the micro-structured conductive object.

The method ends by removing at least a portion of the carrier (70), forming an electrical circuit using the electric conductor such that electric current flows in at least a portion of a medium using the electric conductor (80), and connecting the electrical circuit to a load (90).

The method also contemplates to include the step of penetrating nano-particles from the nano-particle dispersion into the features or pores forming a nano-composite.

The mean average diameter of the nano-particles is between 3 nm and 5 nm. It is envisioned that the dispersion is thermodynamically stable at room temperature and has a viscosity of between 20 centipoids and 300 centipoids.

The dispersion can further include an ultraviolet stabilizer.

In an alternative embodiment, the deposition can be repeated “n” times, where “n” is an integer greater than two in order to form a nano-composite.

The method can also involve a second material, similar to the first material, deposited on the nano-composite prior to repeating the deposition step with the dispersion.

The method can also include the step of depositing “n” nano-particle dispersions. Each dispersion has a metal component different from prior dispersion metal components. Again, “n” is an integer greater than two in order to form a nano-alloy. Each nano-particle dispersion is a different noble metal than the prior nano-particle dispersion.

The micro-structured conductive object method can be a foam, a monolith of porous material, an aero gel, a mat, a felt paper, mesh, laminates thereof, composites thereof, or combinations thereof. In addition, the micro-structured conductive object can be a carbon filled epoxy, a composite, carbon filled polymers, magnelli phase titanium oxide, or combinations thereof.

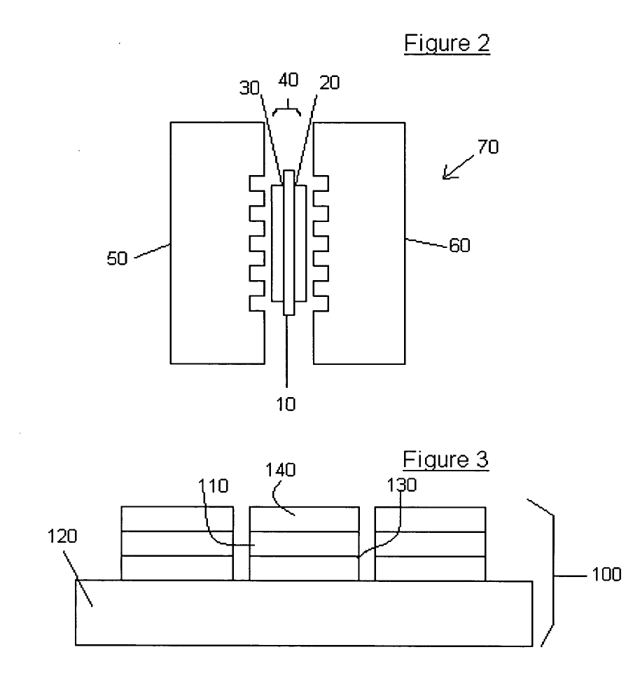

FIG. 2 is a planar electrode (10) that in this case is micro-structured. The electrode could be made of carbon aero gel, metal foam, carbon foam, reticulated carbon foam or a variety of ceramics. The catalyst (20) consists of micro-particles that must be deposited and bonded to the micro-structured electrode. Note the catalyst particles (20) are shown to reside on the surface (30) and the interior (40) of the electrode.

FIG. 3 shows a preferred embodiment in which the colloidal dispersion is used to deposit nano-particles into a high aspect ratio micro-structure. In this example a porous substrate (100) has been processed to create micro-channels (110) with very high aspect ratios. The geometric structure of this device is such that conventional methods of particle deposition cannot work, since they are incapable of providing uniform coverage deep into the formed micro-structure. Since the substrate (100) is porous, the deposition of nano-particles is required to both coat the surface (120) of the micro-structure uniformly and also penetrate some depth into the interior of the micro-structure (130).

The channels (110) in this micro-structure shown in FIG. 3 are typical of micro-structural features, with a channel width between 500 nm and 200 um. More preferably the channels and other features have widths between 5 um and 100 um, with aspect ratios between 1 and 50. By rendering the top (140) of the porous substrate (100) hydrophobic via masking, the nano-particles can be deposited by simply pouring the nano-dispersion onto the surface, whereupon the capillary action of the micro-features pulls the liquid into the structure and the micro-structure of the porous material further pulls the liquid into the substrate itself.

In another embodiment, the electrode can be formed from the nano-composite by etching, cutting, molding, laser treatment, electro-discharge machining, water jet cutting, microinjection molding, packed particle sintering, extruding, deep reactive ion etching, LIGA processing, or combinations thereof.

While this invention has been described with emphasis on the preferred embodiments, it should be understood that within the scope of the appended claims, the invention might be practiced and carried out in other ways than as specifically described herein.

What is claimed is:

1. A method for making an electrode by depositing nano-particles on an object, comprising:
a. forming a nano-particle dispersion comprising;
i. providing between 0.05 wt % and 10 wt % of a charged soluble polymer having a molecular weight of less than 25,000 amu;
ii. providing between 0.5 wt % and 10 wt % of a metal component;
iii. providing between 99.45% and 80% of a carrier; and
iv. mixing the charged soluble polymer, metal component and a carrier;
b. coating an object with the nano-particle dispersion thereby disposing nano-particles from the nano-particle dispersion on the object to form an electric conductor;
c. removing at least a portion of the carrier from the object;
d. forming an electrical circuit using the electric conductor such that electric current flows in at least a portion of a medium using the electric conductor; and
e. connecting the electrical circuit to a load.

2. The method of claim 1, further comprising the removal of at least a portion of the polymer from the object.

3. The method of claim 2, wherein the at least portion of the polymer is removed by a method selected from the group consisting of washing, burning, ablating, pyrolyzing and combinations thereof.

4. The method of claim 1, wherein the carrier is removed by a member selected from the group consisting of evaporation, freezing, critical drying and combinations thereof.

5. The method of claim 1, wherein the nano-particles are crystalline.

6. The method of claim 1, wherein the object is selected from the group consisting of a material containing a micro-structure, a porous material with micro pores, a material into which a micro-structure pattern has been formed, and combinations thereof.

7. The method of claim 1, further comprising forming features on the object, wherein the features have an average width from about 50 nanometers to about 100 microns.

8. The method of claim 1, wherein the object is electrically conductive.

9. The method of claim 1, wherein the object comprises features having an average width from about 50 nanometers to about 100 microns.

10. The method of claim 1, wherein the polymer comprises a member of the group consisting of a polyacrylate, a polymethacrylate, a monomer of acrylates, a sodium acrylate, a potassium acrylate, and combinations thereof.

11. The method of claim 1, wherein the metal component is selected from the group consisting of a noble metal, a transition metal, alloys of noble metals, alloys of transition metals and combinations thereof.

12. The method of claim 1, wherein the carrier is selected from the group consisting of water, low surface tension organic liquids miscible with water and combinations thereof.

13. The method of claim 1, wherein the dispersion comprises a nano-particle having an average diameter of between 1 nm and 50 nm.

14. The method of claim 1, wherein the electric conductor is adapted to conduct current between 0 amps per square centimeter and 100 amps per square centimeter.

15. The method of claim 7, wherein the features comprise pores, capillaries, channels, voids, ridges, fins, embossments, and combinations thereof.

16. The method of claim 15, wherein each of the features have equivalent diameters from about 25 nanometers to about 10 microns.

17. The method of claim 15, wherein each of the features comprise an aspect ratio of 1 or more and an overall width from about 5 nanometers to about 200 microns.

18. The method of claim 1, wherein the object is selected from the group consisting of a foam, a monolith of porous material, an aero gel, a mat, a felt paper, mesh, laminates thereof, composites thereof, and combinations thereof.

19. The method of claim 7, wherein the features are created using a method selected from the group consisting of etching, cutting, molding, laser treatment, electro-discharge machining, water jet cutting, microinjection molding, packed particle sintering, extruding, deep reactive ion etching, LIGA processing and combinations thereof.

20. An electrode made by the method of claim 1.

21. The electrode of claim 20, wherein the electrode is utilized in a fuel cell.
